(19) United States
(12) Patent Application Publication
(10) Pub. No.: US 2024/0317572 A1
(43) Pub. Date: Sep. 26, 2024

(54) HORSE BLANKET

(71) Applicant: LeMieux Ltd, Southampton, Hampshire (GB)

(72) Inventors: Sarah GIBSON, Southampton, Hampshire (GB); Bradley WENTWORTH, Southampton, Hampshire (GB)

(21) Appl. No.: 18/574,936

(22) PCT Filed: Jul. 1, 2022
(86) PCT No.: PCT/GB2022/051707

§ 371 Date: Dec. 28, 2023

(30) Foreign Application Priority Data
Jul. 2, 2021 (GB) 2109588.0

(51) Int. Cl. B68C 5/00

(52) U.S. Cl. CPC B68C 5/00

(57) ABSTRACT

A horse blanket (100) comprising a lower edge (110) at least partially defining a cut out (124), and a flap (138) having a loose edge (136) that overlaps the lower edge (110), the flap (138) being configured to pass through the cut out (124) to wrap against the belly of a horse (116) when the blanket is secured to the horse.

### FIELD OF THE INVENTION

The invention relates generally to horse blankets, otherwise known as horse rugs, such as turn-out rugs, stable rugs, and fly rugs/sheets. In particular, the invention relates to a horse blanket of the type which is secured under the belly of the horse when in use, i.e. when worn by the horse.

### BACKGROUND

Horse blankets, otherwise known as horse rugs, vary in both shape, style and material depending on the intended use. However, generally, horse blankets are designed to lay over the horse's back and to extend down the sides of the horse so that the hemline extends below the horse's elbow at the front end of the blanket and below the stifle at the rear end of the blanket. Horse blankets are generally secured under the belly of the horse, for example with straps, with a portion of the blanket being wrapped under and against the horse's belly.

Factors such as the environmental conditions in which the horse blanket is to be used and the length of time the blanket is to be worn determine which type of horse blanket is most suitable. A type of horse blanket known as a turnout rug offers various levels of outdoor protection against the various environmental conditions to which the horse is exposed, providing both protection from wet weather and thermal insulation in colder conditions. Turnout rugs may therefore have a waterproof or water-resistant outer fabric layer, and an insulating filling material. Indoor blankets, known as stable rugs, provide warmth, comfort, and protection from debris when the horse is stabled. Horse blankets are generally constructed from suitable materials that help to protect the horse and maintain the condition of the horse by providing either a micro-climate within the blanket itself, which helps prevent loss of heat, or assists in moisture wicking and cooling after exercise. Another type of horse blanket known as a fly rug, or fly sheet, is a lightweight blanket that serves to keep flies off of the horse's coat during warmer summer months. Such rugs are also sometimes called sweet itch rugs, as they help to alleviate sweet itch in horses, which is caused by biting insects. Fly rugs are generally constructed from lightweight, breathable materials that are able to keep the horse cool and as such provide an improved level of comfort to the horse. Fly rugs may also be provided with waterproof layers, such as a waterproof top layer over the horse's back to keep the horse dry, thereby providing a waterproof fly rug. Ultimately, horse blankets help to maintain the condition and health of a horse and to improve its comfort and wellbeing.

A major issue with existing horse blankets is the tension caused along the lowest edge, or hemline, of the blanket when the middle portion of the blanket is wrapped under the belly of the horse to secure the blanket on the horse. As the middle portion of the blanket is wrapped under the horse this pulls the hemline of the rug inwards and creates tension in the hemline. This causes the hemline to pull tightly against the horse's fore- and hind legs, which can cause rubbing, sores, hair loss, and blisters, while also restricting movement of the horse and generally causing discomfort. Tension in the hemline is further increased as the horse's forelegs stretch forwards when the horse walks. The horse's chest is also affected as the hemline becomes taught when the horse's forelegs stretch forwards, causing the material to move upwards and across the chest. The tension in the hemline also causes creasing and bulking of material behind the horse's forelegs and in front of the hind legs, further restricting mobility. Injuries sustained by a horse due to tension in the hemline of the blanket may ultimately affect the performance of the horse and its natural gait. Over a prolonged period this could result in stiffness, lameness, and devaluation the horse due to its inability to perform at optimum. This could also result in claims made for loss of use and/or long-term injury to the horse.

Various horse blankets have been developed in an attempt to address the problem of tension in the hemline, with some such blankets, such as that described in EP2353378 B1, featuring a gusset or pleat. While this solution is said to contribute to reducing the tension of the hemline, it also presents other issues such as the creation of bulk and added weight to the horse blanket, and the loose gusset material may also gather within the blanket and rub against the horse, causing friction and sore points behind the forelegs. Adding material to create the gusset also increases the overall length of the blanket when it is fully extended. As the pleated gusset opens out due to movement of the horse the blanket increases in length. The blanket then has no way of retracting once the gusset has opened, which causes the rear of the blanket to overhang the horse's tail. The excess material adds weight to the rear of the horse blanket, which creates further pressure to the front chest and the hemline, which in turn increases risk of friction related injury. The incorporation of a pleated gusset therefore brings with it its own problems.

Other blankets, such as that described in EP1469718 B1, incorporate shaped hemlines to alleviate tension, however the tension is only partially alleviated by such shaped hemlines, and twisting and distortion of the hemline still results when tension is created by movement of the horse's forelegs. This can cause parts of the hemline to either curl out, which exposes the horse blanket to the elements and lessens protection, or curl in towards the horse, which causes friction to the horse's legs.

A close anatomical fit of the blanket on the horse is also required to ensure that the protection provided by the rug is optimised in all environmental climates and to enable the blanket to provide a micro climate within the rug, helping to maintain the health, wellbeing and coat condition of the horse. Existing rugs often fail to provide a close anatomical fit and therefore fail to provide these benefits.

The present invention provides an improved horse blanket that addresses the various disadvantages associated with existing horse blankets.

### SUMMARY OF THE INVENTION

The invention provides a horse blanket. The horse blanket may comprise a lower edge at least partially defining a cut out. The blanket may further comprise a flap. The flap may comprise a loose edge that overlaps the lower edge, the flap being configured to pass through the cut out to wrap against the belly of a horse when the blanket is secured to the horse.

The cut out may be defined, at least in part, by the lower edge.

The lower edge may have the cut out formed therein.

The loose edge of the flap may overlap or overhang the lower edge within the cut out.

The loose edge of the flap may comprise a front flap edge and a rear flap edge. The front and rear flap edges may overlap the lower edge within the cut out.

The lower edge may be discontinuous with the loose edge of the flap.

The flap may partially overlay or overlap the cut out in use. The flap may be partially disposed over the cut out in use.

The cut out may be located between a front portion of the lower edge and a rear portion the lower edge.

The front portion of the lower edge may extend or fall below an elbow of the horse and a rear portion of the lower edge may extend or fall below a stifle of the horse.

The cut out may partially define a front lower portion of the blanket and a rear lower portion of the blanket, the cut out being located between the front lower portion and the rear lower portion. The cut out may at least partially separate the front and rear lower portions of the blanket.

The front lower portion of the blanket may be disposed over an upper part of a foreleg of the horse when the blanket is worn by the horse. The rear lower portion of the blanket may be disposed over an upper part of a hind leg of the horse when the blanket is worn by the horse.

The front lower portion of the blanket may be disposed over (i.e. cover) an elbow of the horse when the blanket is worn by the horse. The rear lower portion of the blanket may be disposed over (i.e. cover) a stifle of the horse when the blanket is worn by the horse.

The flap may partially overlap or overlay the front and rear lower portions of the blanket.

The cut out may be situated adjacent or proximate to a flank or the belly of the horse when the blanket is worn by the horse.

The cut out may be defined, at least in part, by a raised portion of the lower edge. The raised portion may be a middle portion located between the front and rear portions of the lower edge.

The cut out may extend or rise to approximately the lowest level of the belly of the horse or higher when the lower edge is allowed to hang freely (i.e. before the flap is wrapped against the belly of the horse).

The cut out may extend or rise above the lowest level of the belly of the horse when the lower edge is allowed to hang freely.

The lower edge and the loose edge of the flap may cooperate to at least partially define or form a hemline of the blanket. The hemline may be discontinuous (e.g. it may not form a single continuous seam or edge that is physically continuous or connected along its length). The hemline may have discontinuities where the lower edge and the loose edge of the flap overlap.

The lower edge may be continuous. The lower edge may be discontinuous.

The flap may extend or fall below the lowest point of the lower edge when allowed to hang freely.

The flap may have a tapered profile that reduces in width towards its lower end.

The cut-out may have a tapered profile that increases in width towards its lower end.

The loose edge of the flap may cooperate with the lower edge to define a front notch in the hemline. The front notch may be located between the flap and the front lower portion of the blanket when the flap is wrapped against the belly of the horse.

The front notch may be located adjacent to or rearwards of an elbow of the horse when the horse is stood in the square halt position while wearing the blanket. The front notch may be located proximate to an elbow of the horse when the horse is stood in the square halt position while wearing the blanket.

The loose edge of the flap may cooperate with the lower edge to define a rear notch in the hemline. The rear notch may be located between the flap and the rear lower portion of the blanket when the flap is wrapped against the belly of the horse.

The rear notch may be located adjacent to or forwards of a stifle of the horse when the horse is stood in the square halt position while wearing the blanket. The rear notch may be located proximate to a stifle of the horse when the horse is stood in the square halt position while wearing the blanket.

The front and rear notches may provide a means for reducing tension in the lower edge of the blanket when the flap is wrapped against the belly of the horse.

The blanket may comprise a main part that extends across the back of the horse and down each side of the horse, the main part comprising the flap, and a skirt part attached to the main part, wherein the lower edge of the skirt part is the lower edge of the blanket.

The skirt part may be attached to the underside of the main part.

The main part may comprise a lower edge, the lower edge of the main part defining the loose edge of the flap.

The flap may be a protrusion in the lower edge of the main part.

The skirt part may comprise the front lower portion and the rear lower portion of the blanket.

The skirt part may be waterproof or water resistant.

Both surfaces (i.e. the top layer and the lining layer) of the skirt part may be constructed from waterproof or water-resistant material.

The skirt part may comprise a waterproof top layer and a waterproof lining layer, the top layer and lining layer both being surface (i.e. outer) layers of the skirt part.

The skirt part does may lack (i.e. not comprise) a filling material.

The main part may comprise a filling material, such as an insulating filling material.

The blanket may comprise a main part that extends across the back of the horse and down each side of the horse, wherein a lower edge of the main part forms the lower edge of the blanket, and the flap may be attached to the main part.

The flap may partially overlay or overlap the main part.

The blanket may further comprise one or more straps configured to extend or wrap under the belly of the horse to secure the blanket on the horse. The straps may overlay the flap when the blanket is secured to the horse to hold the flap against the belly of the horse.

The flap may be configured to wrap under the belly of the horse from one side of the horse to meet a second flap of the blanket wrapped under the belly of the horse from the opposing side of the horse.

The flaps (on each side of the blanket) may each comprise a hook-and-loop fastening strip for securing the flaps together under the belly of the horse.

The lower edge may be a first lower edge of the blanket. The blanket may further comprise a second lower edge, the second lower edge defining the loose edge of the flap.

The horse blanket may comprise a first side and a second side, the first side comprising the lower edge and the flap.

The horse blanket may comprise a first side and a second side, each of the sides of the blanket may comprise: a lower edge at least partially defining a cut out, and a flap, as defined above.

Also disclosed is a horse blanket comprising a first part having a lower edge, the lower edge having a cut out defined therein; and a flap having a loose edge that overlaps the lower edge of the first part, the flap being configured to pass through the cut out to wrap against the belly of a horse when the blanket is secured to the horse.

The lower edge of the first part and the loose edge of the flap may cooperate to define a discontinuous hemline of the blanket.

The flap may be attached to the first part.

The flap may at least partially overlap or overhang the first part.

The first part may be a main part of the blanket or a skirt part of the blanket.

The flap may be attached to the top edge of the cut out.

It will be appreciated that other formulations of the invention are possible based on the disclosure of the invention herein and that the above summary merely sets out some formulations that are non-limiting in nature.

### BRIEF DESCRIPTION OF FIGURES

The invention will now be described by way of example only with reference to the accompanying figures, in which:

FIG. 1a is a left-side view of a horse blanket in accordance with the invention with the flap hanging freely and not yet secured against the belly of the horse.

FIG. 1b is a left-side view of a skirt part of the horse blanket illustrated in FIG. 1a.

FIG. 1c is a left-side view of a main part of the horse blanket illustrated in FIG. 1a.

FIG. 1d is a perspective view of the horse blanket illustrated in FIG. 1a.

FIG. 1e is a left-side view of the horse blanket illustrated in FIG. 1a.

FIG. 1d is a right-side view of the horse blanket illustrated in FIG. 1a.

FIG. 2a is an exploded perspective view of the layers of a skirt part of the horse blanket illustrated in FIG. 1a.

FIG. 2b is an exploded perspective view of the layers of a main part of a horse blanket illustrated in FIG. 1a.

FIG. 3a is a left-side view of another horse blanket in accordance with the invention with the flap hanging freely and not yet secured against the belly of the horse.

FIG. 3b is a left-side view of the horse blanket illustrated in FIG. 3a with the flap secured against the belly of the horse.

FIG. 3c is a view of the inside of the right-hand side of the horse blanket illustrated in FIG. 3a.

FIG. 4a is a left-side view of another horse blanket in accordance with the invention.

FIG. 4b is a left-side view of the horse blanket illustrated in FIG. 4a with the flap detached from the main part.

FIG. 4c is a left-side view of the horse blanket illustrated in FIG. 4a worn by a horse with the flap secured against the belly of the horse.

Unless otherwise stated, the same or alike reference numerals denote the same or equivalent features throughout the drawings. Reference numerals that differ by 100 or a multiple thereof generally correspond to the same or equivalent features in each of the figures.

### DETAILED DESCRIPTION

For brevity, features or aspects of the invention may be described in the context of a particular embodiment of the invention, but it should be understood that features described in the context of a particular embodiment may be applied to the invention as defined more generally, for example in the claims, without necessarily also requiring the inclusion of other features from that embodiment. Similarly, features that are described in the context of separate embodiments of the invention may be used together and/or be interchangeable wherever possible.

The term “horse” is intended to mean an equine animal, including ponies and foals. A horse blanket, or rug, is a garment for a horse that lays over the horse's back and extends down the sides of the horse. Horse blankets in accordance with the invention generally extend below the horse's elbow at the front end of the blanket and below the stifle at the rear end of the blanket when worn by a horse, thereby covering the upper portions of the horse's forelegs and hindlegs. The hemline (or lowest edge), of the blanket therefore generally falls below the horse's elbow at the front end of the blanket and below the stifle at the rear end of the blanket. Where the blanket is described with reference to a horse or a part of a horse in the description that follows, it should be understood that this refers to the arrangement of the blanket in use, i.e. when worn by a horse, generally while the horse is stood in the square halt dressage position.

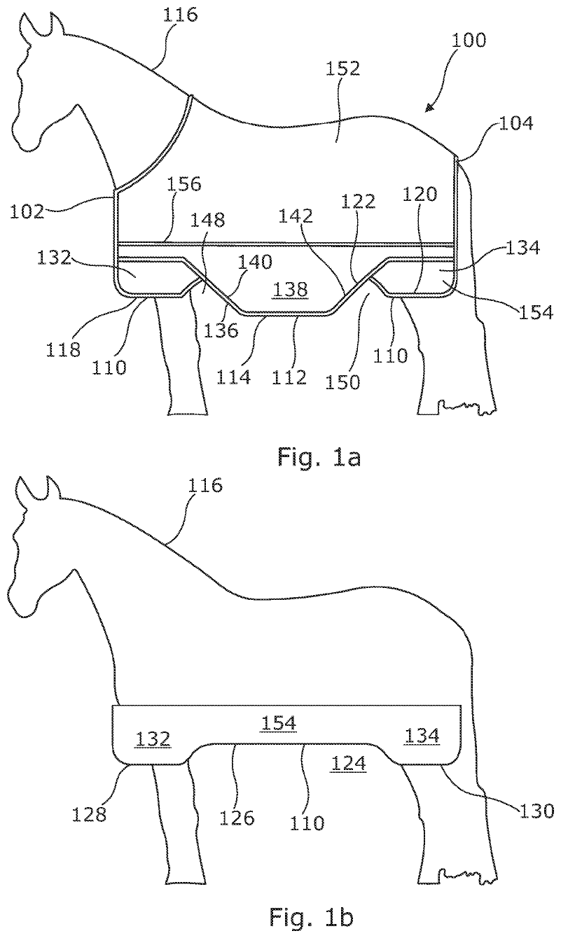

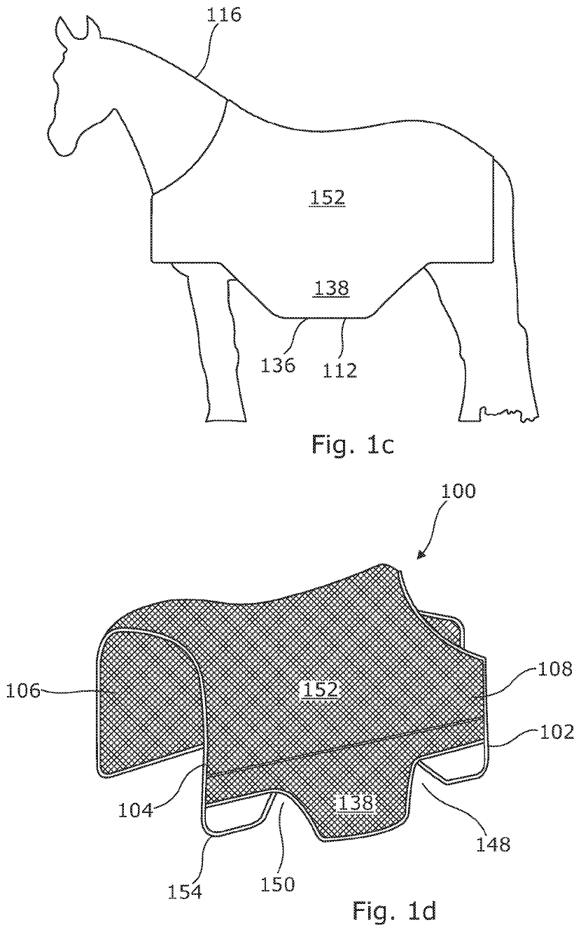

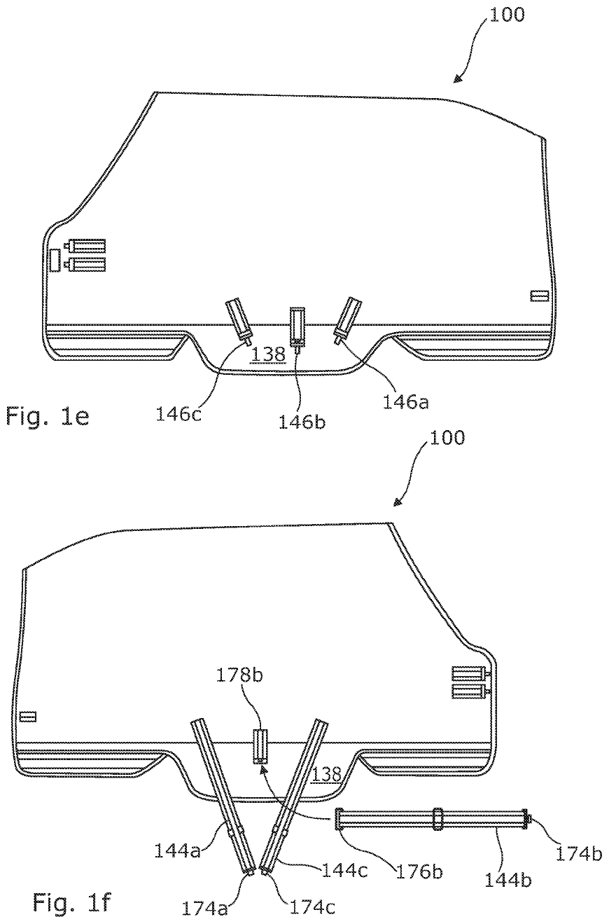

Referring to FIGS. 1a to d, a horse blanket 100 in accordance with the invention comprises a front edge 102 and a rear edge 104. The blanket 100 comprises two sides, a left side 106 and a right side 108. Both sides of the blanket 100 may comprise corresponding features and may be configured in generally the same way. For brevity and clarity, only a single side of the blanket 100 is generally described below, but it should be understood that the second side may be configured in largely the same manner.

The blanket 100, specifically a side 106, or each side 106, 108, of the blanket 100, comprises a first lower edge 110 and a second lower edge 112. The first 110 and second 112 lower edges cooperate to at least partially define a hemline 114 of the blanket 100. As used herein, the term “hemline” is used to refer to the lowest edge of the blanket 100 when the blanket 100 is worn by a horse 116, whether freely hanging or wrapped against the horse's body. Each of the first 110 and second 112 lower edges defines at least a part of the hemline 114 of the blanket 100. The first lower edge 110 defines a front portion 118 and a rear portion 120 of the hemline 114, and the second lower edge 112 defines a middle portion 122 of the hemline 114 located between the front 118 and rear 120 portions. The front 118 and rear 120 portions of the hemline 114 defined by the first lower edge 110 pass across, or overlay, a foreleg and a hind leg of the horse, respectively. In other words, the front 118 and rear 120 portions of the hemline 114 defined by the first lower edge 110 include the portions of the hemline 114 that are located adjacent to, or disposed over, a horse's fore- and hind legs, respectively, when the blanket 100 is worn be the horse 116 and the horse is stood in the square halt position. The front portion 118 of the hemline 114 extends in a rearward direction to a point rearward of the foreleg, and the rear portion 120 of the hemline 114 extends forward to a point forward of the hind leg. The middle portion 122 of the hemline 114 is located between the horse's fore- and hind legs when the horse 116 is stood in the square halt position and forms the portion of the hemline 114 between the front 118 and rear 120 portions. The first lower edge 110 is discontinuous with the second lower edge 112 (i.e. they are separate and are not directly connected or affixed to each other) and together the first lower edge 110 and the second lower edge 112 define a discontinuous hemline 114. As is described in further detail below, this relieves tension along the hemline 114 when the blanket 100 is secured under the belly of the horse 116.

The first lower edge 110 extends from the front edge 102 of the blanket 100 to the rear edge 104 of the blanket 100. The first lower edge 110 has a cut out 124 formed therein. In other words, the first lower edge 110 at least partially defines a cut out 124 in the blanket 100. The cut out 124 is located towards the middle of the first lower edge 110 and is defined by a middle portion 126 of the first lower edge 110. The cut out 124 is therefore located between a front portion 128 of the first lower edge and a rear portion 130 the first lower edge. The cut out 124 is defined by a raised portion of the first lower edge 110 that is raised above the levels of the front 128 and rear 130 portions of the first lower edge 110. The cut out 124 is located adjacent or proximate to the horse's belly when the blanket 100 is worn by the horse 116. In the blanket 100 illustrated in FIGS. 1a to d, the top edge of the cut out 124 (i.e. the portion of the first lower edge 110 defining the top edge of the cut out 124) extends to approximately the level of the lowest point of the belly of the horse 116 when the first lower edge 110 is allowed to hang freely. The cut out 124 is generally located between the fore- and hind legs of the horse 116 when the horse 116 is stood in the square-halt position. For example, the cut out may extend from a point on the first lower edge proximate to a foreleg of the horse to a point on the first lower edge proximate to a hind leg of the horse.

The cut out 124 partially defines a front lower portion 132 of the blanket 100 and a rear lower portion 134 of the blanket 100, with the cut out 124 located between the front lower portion 132 and the rear lower portion 134. In use, the front lower portion 132 of the blanket 100 is disposed over (i.e. covers) an upper part of a foreleg of the horse 116 when the blanket 100 is worn by the horse 116, and the rear lower portion 134 of the blanket 100 is disposed over an upper part of a hind leg of the horse 116 when the blanket 100 is worn by the horse 116. In particular, the front lower portion 132 may be disposed over an elbow of the horse 116, and the rear lower portion 134 may be disposed over a stifle of the horse 116 (i.e. the elbow and stifle on the same side of the horse 116 as the relevant side 106, 108 of the blanket 100). The front portion 128 of the first lower edge, which defines the lower edge of the front lower portion 132 of the blanket 100, therefore extends below the level of the elbow of the horse 116, and the rear portion 130 of the first lower edge, which defines the lower edge of the rear lower portion 134 of the blanket 100, therefore extends below the level of the stifle of the horse 116. In other words, the hemline 114 of the blanket 100 falls below the elbow at the front end of the blanket 100 and below the stifle at the rear end of the blanket 100. The front 128 and rear 130 portions of the first lower edge may extend to the same level, i.e. they may be level with each other, as in the embodiment illustrated in FIGS. 1a to d.

The second lower edge 112 defines the loose edge 136 of a flap 138 configured to pass through the cut out 124 and between the fore- and hind legs of the horse to wrap against the belly of a horse 116 when the blanket 100 is secured to the horse 116. In particular, the flap 138 may be wrappable under the belly of the horse 116 to secure the blanket 100 on the horse 116. The portion of the second lower 112 edge that defines the loose edge 136 of the flap 138 overlaps or overhangs the first lower edge 110 within the cut out 124, and the flap 138 extends downwardly to partially overlay or overlap the cut out 124. The flap 138 is therefore disposed, in part, over the cut out 124 when allowed to hang freely, and also when wrapped under the belly of the horse 116. The flap 138 may therefore be said to overhang the first lower edge 110 within the cut out 124. The loose edge 136 of the flap 138 comprises a front edge 140 and a rear edge 142, and both the front 140 and rear 142 edges of the flap 138 overlap the first lower edge 110 within the cut out 124. In other words, the loose edge 136 of the flap 138 overlaps the first lower edge 110 only within the cut out 124. The loose edge of the flap 136 overlaps the first lower edge 110 only between the fore- and hind legs of the horse when the horse is stood in the square halt position. Specifically, the front edge 140 of the flap overlaps the first lower edge 110 at a point rearward of a foreleg of the horse 116 (e.g. rearward of an elbow of the horse) and the rear edge 142 of the flap overlaps the first lower edge 110 at a point forward of a hind leg of the horse 116 (e.g. forward of a stifle of the horse) when the blanket is secured to the horse 116. The loose edge 136 of the flap 138, being loose, is not affixed to the first lower edge 110 where the two overlap, which means that the loose edge 136 of the flap 138 can move freely over the first lower edge 110. This means that when the flap 138 is wrapped under the belly of the horse 116 the tension in the loose edge 136 of the flap 138 is not directly transferred to the first lower edge 110 and tension in the hemline 114 is thereby reduced. The discontinuous hemline 114 formed by the first lower edge 110 and the second lower edge 112/loose edge 136 of the flap 138 therefore provides a means for reducing the tension in the hemline 114 that is otherwise caused when the blanket 100 is wrapped under the belly of the horse 116 to secure the blanket 100 in place. The discontinuous hemline 114 comprises the front 118 and rear 120 portions defined by the first lower edge, and middle portion 122 defined by the second lower edge 112/loose edge of the flap 136, with discontinuities between these portions where the loose edge 136 of the flap 138 overlaps the first lower edge 110.

Referring to FIGS. 1e and 1f, the blanket 100 comprises straps 144a, 144b, 144c that are arranged to wrap under the belly of the horse 116 to secure the blanket 100 to the horse 116. The straps 144a, 144b, 144c overlay the flap 138 to hold the flap 138 against the belly of the horse 116 when the blanket 100 is secured to the horse 116, thereby providing protection to the horse 116 from mud, water, and debris. Where both sides of the blanket 100 comprise a flap 138, the straps 144a, 144b, 144c overlay both flaps to hold them against the belly of the horse 116. One side 108 of the blanket 100 may be provided with straps 144a-c. Each of the straps 144a-c may have a fastener 174a-c provided at a distal end thereof. The other side 106 may be provided with corresponding fasteners 146a-c configured to secure the straps 144a-c in place by engaging with the fasteners 174a-c provided on the straps, thereby securing the two sides 106, 108 of the blanket 100 together under the belly of the horse 116. The fasteners 174a-c provided on the straps 144a-c may be a T-bar or other hook-like fasteners, and the fasteners 146a-c provided on the other side of the blanket 100 may be configured to receive the T-bar or other type of fasteners 174a-c provided on the straps 144a-c to secure the straps in place. Alternatively, both sides of the blanket 100 may be provided with straps that are fastened together under the belly of the horse 116, with the straps provided with fasteners to secure them together. If both sides 106, 108 of the blanket 100 comprise a flap 138, the flaps may be of sufficient length such that they meet when wrapped under the belly of the horse 116, and the flaps may be provided with complementary hook-and-loop fastening strips (e.g. VELCRO®) so that they can be secured to each other under the belly of the horse 116, thereby preventing relative movement of the flaps, which in turn reduces rubbing and bagging or otherwise undesirable displacement of material that could cause discomfort to the horse 116. Straps 144a, 144b and/or 144c may be detachable from the blanket 100, as may fasteners 146a, 146b and/or 146c. This has the advantage that any metal fasteners or other metal components of the straps or fasteners may be removed from the blanket 100 prior to washing or laundering the blanket 100, thereby avoiding damage to the washing machine. The detachable nature of the straps 144a-c and fasteners 146a-c also means that the number of straps may be selected according to the requirements of the blanket. For example, it may be decided to dispense with the central strap 144b and use only straps 144a and 144c. Each of straps 144a, 144b, 144c (and fasteners 146a-c) may be secured to the blanket 100 by threading a respective fabric flap attached to the blanket 100 through a hoop (e.g. hoop 176b) provided on the strap (or fastener). The fabric flap may then be folded up against the side of the blanket 100 and secured against the side of the blanket 100 by engaging a hook-and-loop fastening strip provided on the fabric flap, specifically on the side of the fabric flap that rests against the side of the blanket 100 when the flap is folded up, with a complementary hook-and-loop fastening strip provided on the side of the blanket 100, for example on flap 138. A second fabric flap may then be folded down over the first fabric flap and secured against the first fabric flap by engaging a hook-and-loop fastening strip on the second fabric flap with a complementary hook-and-look fastening strip on the first fabric flap. The blanket may therefore be provided with strap/fastener attachment points (e.g. 178b) for attaching each of straps/fasteners to the blanket, the attachment points each comprising the fabric flaps and hook-and-loop fastening strips described above for detachably securing the straps 144a-c and/or the fasteners 146a-c to the blanket 100. This provides a secure means for attaching the straps 144a-c and fasteners 146a-c to the blanket 100 in an easily detachable manner.

The flap 138 may have a tapered profile that reduces in width towards its lower end so that the flap 138 is wider (as measured along the length of the blanket 100) at its upper end than at its lower end, and the cut-out may have a tapered profile that increases in width towards its lower end so that the cut out 124 is wider at its lower end than at its upper end. The flap 138 is generally shaped so that it avoids contact with the fore- and hind-legs of the horse 116 when wrapped under the belly of the horse 116 in use so as to avoid rubbing and causing injury or discomfort to the horse 116, and the tapered profile aids in drawing the blanket 100 snugly against the horse 116 along the length of the horse's torso.

The second lower edge 112, specifically the loose edge 136 of the flap 138, and the first lower edge 110 cooperate to define a front notch 148, or void, in the hemline 114 when the flap 138 is wrapped against the belly of the horse 116. The front notch 148 is formed between the flap 138 and the front lower portion 132 of the blanket 100. The loose edge 136 of the flap 138 and the first lower edge 110 of the blanket 100 overlap to form an apex at the top of the front notch 148. In other words, the front notch 148 comprises an apex at its top end where the loose edge 136 of the flap 138 and the first lower edge 110 overlap. The loose edge 136 of the flap 138, specifically the front edge 140 of the flap 138, defines a rear edge of the notch and the first lower edge 110 of the blanket 100 defines a front edge of the notch. The front notch 148 is located adjacent to or rearwards of a foreleg of the horse 116 when the horse 116 is stood in the square halt position while wearing the blanket 100. In particular, the front notch 148 may be located proximate to (i.e. adjacent to or slightly rearward of) an elbow of the horse 116 when the horse 116 is stood in the square halt position while wearing the blanket 100. The front notch 148 helps to avoid rubbing and friction in the elbow region of the horse 116 when the blanket 100 is wrapped under the belly of the horse 116 and further relieves tension in the hemline 114 by extending the length of the hemline 114. The front notch 148 also prevents bulking of material behind the horse 116's foreleg.

Similarly, the second lower edge 112, specifically the loose edge 136 of the flap 138, and the first lower edge 110 may cooperate to define a rear notch 150, or void, in the hemline 114 when the flap 138 is wrapped against the belly of the horse 116. The rear notch 150 is formed between the flap 138 and the rear lower portion 134 of the blanket 100. The loose edge 136 of the flap 138 and the first lower edge 110 of the blanket 100 overlap to form an apex at the top of the rear notch 150. In other words, the rear notch 150 comprises an apex at its top end where the loose edge 136 of the flap 138 and the first lower edge 110 overlap. The loose edge 136 of the flap 138, specifically the rear edge 142 of the flap 138, defines a front edge of the rear notch 150 and the first lower edge 110 of the blanket 100 defines a rear edge of the notch. The rear notch 150 is located adjacent to or forwards of a hind leg of the horse 116 when the horse 116 is stood in the square halt position while wearing the blanket 100. In particular, the rear notch 150 may be located proximate to (i.e. adjacent to or slightly forward of) a stifle of the horse 116 when the horse 116 is stood in the square halt position while wearing the blanket 100. The rear notch 150 helps to avoid rubbing and friction in the stifle region of the horse 116 when the blanket 100 is wrapped under the belly of the horse 116 and further relieves tension in the hemline 114 by extending the length of the hemline 114. The rear notch 150 also prevents bulking of material in front of the horse's hind leg.

A further advantage of the front 148 and rear 150 notches is enhanced breathability and improved airflow around vital regions. The front notch 148 increases breathability in the region where the horse's vital organs are situated. The rear notch 150 provides breathability and airflow around a male horse's sexual organs and a female horse's milk supply to her foal.

The flap 138 may extend below the lowest point of the first lower edge 110 when allowed to hang freely, and as such may extend below the lowest parts of the front 132 and rear 134 lower portions of the blanket 100 when allowed to hang freely. This extended length of the flap 138 compared to the front and rear portions of the hemline 114 allows the flap 138 to extend further around the belly of the horse 116 and permits the two flaps from either side to meet, thereby improving the coverage and protection of the horse 116 by the blanket 100 and improving the fastening of the two sides 106, 108 of the blanket 100 together.

As illustrated in FIGS. 1a to d, the blanket 100 may comprise a main, or top, part 152 that extends across the back of the horse 116 and down each side of the horse 116 and, a lower, or skirt, part 154 attached to the main part 152. The skirt part 154 may be in the form of a single panel, and may therefore be referred to as the skirt panel or lower panel. The main part 152 comprises the flap 138 (and, if present, the flaps on both sides 106, 108 of the blanket 100). In particular, the main part 152 comprises a lower edge (and in fact may comprise left and right lower edges on the respective sides of the main part) that forms the second lower edge 112 of the blanket 100, and the loose edge 136 of the flap 138 is therefore at least a portion of the lower edge of the main part 152. In other words, the lower edge of the main part 152 defines or forms the loose edge 136 of the flap 138. The flap 138 is formed as a protrusion in the lower edge of the main part 152. The main part 152 may be in the form of a single panel and may therefore be referred to as a top or main panel.

The skirt part 154 is attached to the underside of the main part 152 and the main part 152 partially overlays the skirt part 154. The skirt part 154 may, for example, be attached to the underside of the main part 152 along a stitching line 156, which may extend along the length of the blanket 100 substantially horizontally. The lower edge of the skirt part 154 forms or defines the first lower edge 110 of the blanket 100. In other words, the lower edge of the skirt part 154 is the first lower edge 110 of the blanket 100. The skirt part 154 comprises the front lower portion 132 and the rear lower portion 134 of the blanket 100, and the lower edge of the skirt part 154 forms the front and rear portions of the hemline 114 of the blanket 100.

The front edges of the main 152 and skirt 154 parts may cooperate to define, at least in part, the front edge 102 of the blanket 100, and the rear edges of the main 152 and skirt 154 parts may cooperate to define, at least in part, the rear edge of the blanket 100. The main 152 and skirt 154 parts of the blanket 100 may be fastened or secured together along their front and rear edges. In other words, the front edges of the main 152 and skirt 154 parts may be secured together, as may the rear edges of the main 152 and skirt 154 parts. For example, an edge binding or edge tape may secure the main 152 and skirt 154 parts together along their front and rear edges. This helps to keep the rug close-fitting and secured in place by ensuring that the flap 138 also keeps the front and rear edges of the blanket 100 in place when secured under the belly of the horse 116. Binding the front and rear edges of the two parts 152, 154 together also causes the flap 138 to exert inward pressure along the entire length of the blanket 100, thereby ensuring a snug fit against the horse 116, and also prevents the front and rear ends of the main part 152 below the stitching line 156 that secures the main 152 and skirt 154 parts together becoming snagged or caught.

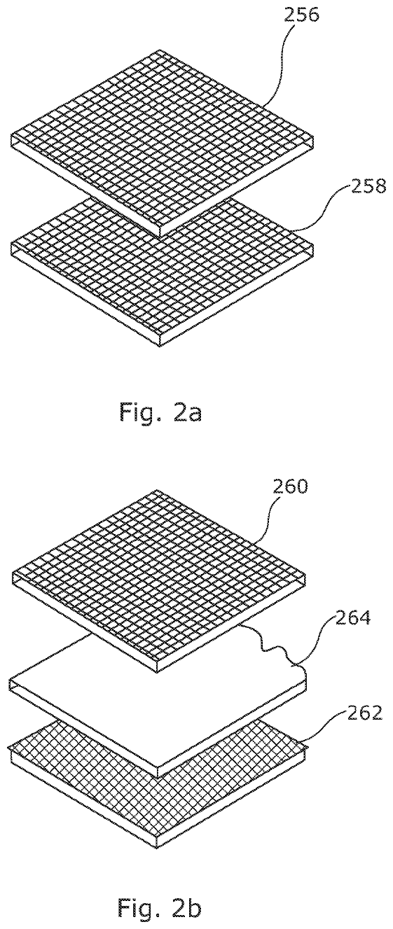

The skirt, or lower, portion of a horse blanket is often in contact with the ground when the horse is in the field, either lying down or rolling, and must typically be robust and waterproof to prevent the blanket becoming waterlogged and heavy. It is also susceptible to splash back from loose earth lifted by the horse when in motion. The two-part construction of a main part 152 and a separate skirt part 154 allows the skirt part 154 and the main part 152 to be manufactured from different materials, thereby optimising the properties of each part of the blanket 100. In particular, the skirt part 154, or lower panel, may be waterproof or water-resistant, and may therefore comprise waterproof or water-resistant surface layers. In other words, both sides of the lower panel 154 may have waterproof or water-resistant surface, or outer, layers. Referring to FIG. 2a, the lower panel 154 may be constructed from, i.e. may comprise, a waterproof or water-resistant top layer 256 (i.e. outward-facing surface layer), and a waterproof or water-resistant lining layer 258 (i.e. inward-facing surface layer). The top layer 256 and the lining layer 258 may each be formed from waterproof or water-resistant fabric, such as a woven fabric. Having waterproof or water-resistant surface layers on both sides of the lower panel 154 is advantageous because both sides of the lower panel 154 may come into contact with the ground and may therefore become wetted or soiled. The lower panel 154 may also lack a filling material between the surface layers to make it thinner, lighter weight, and resistant to water uptake. The lower panel 154 may also be constructed from reinforced material to improve its strength and robustness. Limiting reinforcement and full waterproofing to the lower skirt portion of the blanket 100 results in the horse being less restricted in its movements than would otherwise be the case if the entire blanket 100 were fully waterproofed and reinforced.

In contrast, referring to FIG. 2b, the main part 152 of the blanket 100 may to comprise a waterproof or water-resistant top layer 260 (i.e. outward-facing surface layer), and a lining layer 262 (i.e. inward-facing surface layer) that is not waterproof or water resistant and is instead constructed from a lining fabric, which may be breathable and may have anti-static and/or anti-bacterial properties. The use of a lining fabric on the inside surface of the main part 152 improves the comfort and condition of the horse. Unlike the skirt portion of the blanket 100 formed by the lower panel 154, it is not necessary to use waterproof or water-resistant materials on the inside of the main part 152 of the blanket 100 as this part does not come into contact with the ground during normal use of the blanket 100. The main part 152 may also comprise one or more filling materials 264, such as insulating filling material, between the top 260 and lining 262 layers if the blanket 100 is intended for use in cold conditions. The insulating filling material 264 may for example comprise a thermo-bonded polyester filling material.

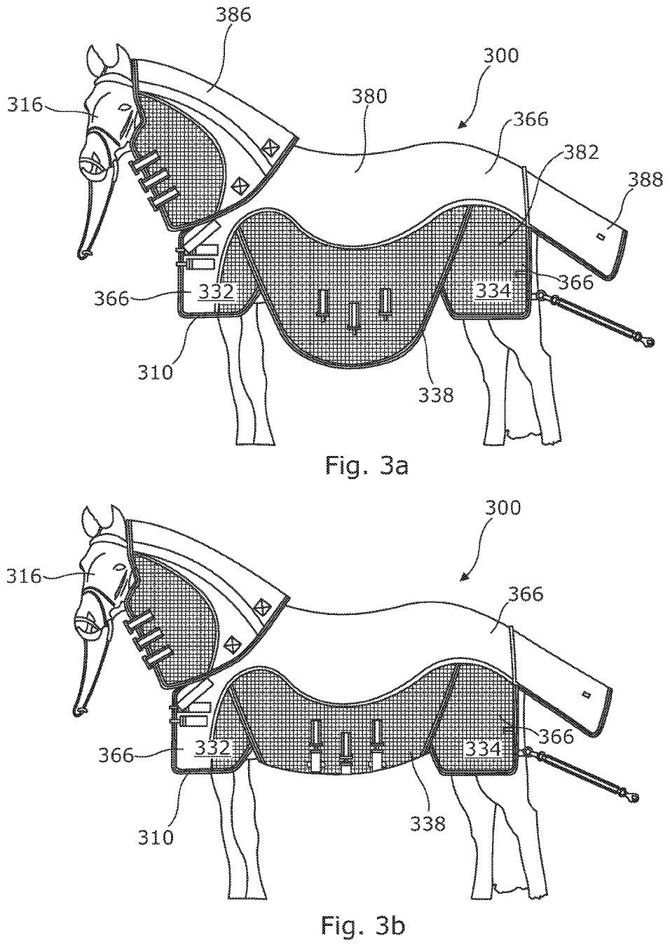

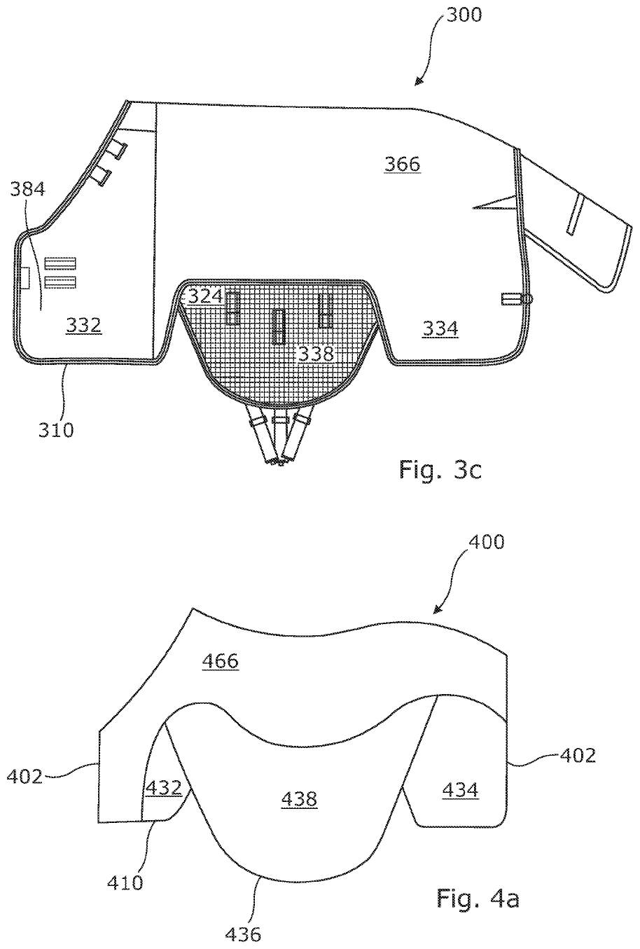

Referring to FIGS. 3a to c, a horse blanket 300 in accordance with the invention may instead comprise a main part 366 that extends across the back of the horse 316 and down each side of the horse 316, the lower edge of which forms or defines the first lower edge 310 of the blanket 300. In other words, the lower edge of the main part 366 may be the first lower edge 310 of the blanket 300. The main part 366 may therefore have the cut-out 324 defined therein, i.e. formed in the lower edge thereof. The flap 338 may be attached to the main part 366 so that the flap 338 partially overlaps or overlays the main part 366. The main part 366 may, in particular, partially overlap the front 332 and rear 334 lower portions of the blanket 300, which are formed by portions of the main part 366. This overlap ensures that the horse 316 is well-covered by the blanket 300 and that parts of the horse 316 are not inadvertently exposed when the flap 338 is secured under the belly of the horse 116 and is pulled inwards. The main part 366 may be constructed from multiple panels and need not be formed as a single panel or sheet of material.

The cut out 324 may extend above the lowest level of the belly of the horse 316 when the first lower edge 310 is allowed to hang freely, and at least a portion of the cut out 324 may lie adjacent to a flank of the horse 316 when the blanket 300 is worn by the horse 316. In other words, the top edge of the cut out 324 may lie adjacent to a flank of the horse 316 in use.

The blanket 300 shown in FIGS. 3a-c is a waterproof fly rug, or fly sheet, and the main part 366 comprises a waterproof top layer 380 that extends across the horse's back and which overlays a mesh under layer 382. The front end of the main part 366 is also provided with a liner layer 384 on the inside for improved comfort for the horse 316. The flap 338 is made from a mesh fabric similar to the under layer 382 of the main part 366. Of course, the design principles illustrated by FIGS. 3a-c may be applied to other types of blanket, such as turn-out rugs. FIGS. 3a and 3b also show the blanket coupled with optional neck cover or neck protector 386 and optional tail flap 388.

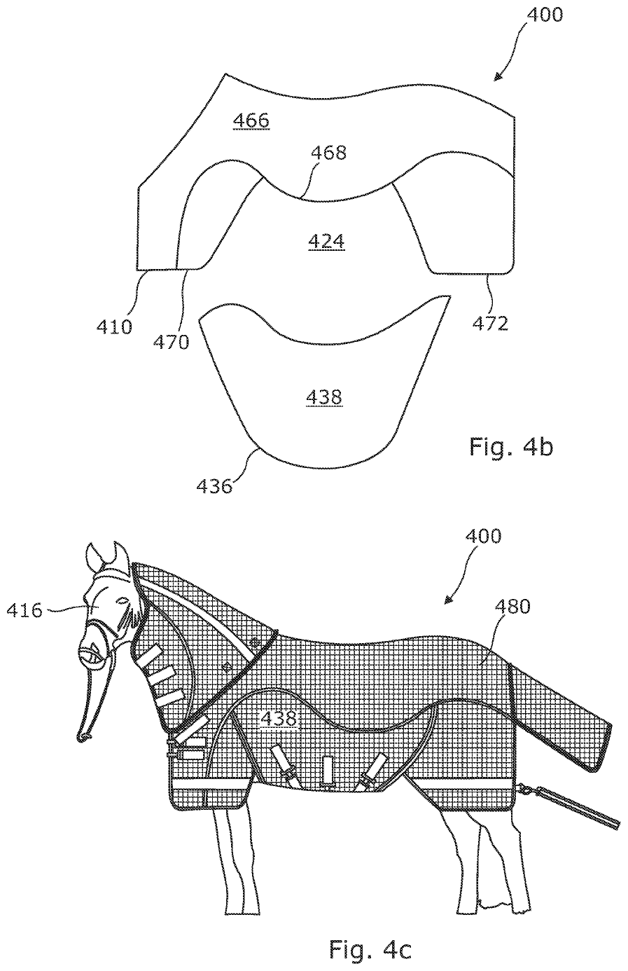

Referring to FIGS. 4a to 4c, a similar blanket 400 to that illustrated in FIGS. 3a to d is shown, comprising a main part 466 that extends across the back of the horse 416 and down each side of the horse 416, the lower edge of which forms or defines the first lower edge 410 of the blanket 400, and a flap 438 attached to the main part 466 so that the flap 438 partially overlaps or overlays the main part 466. However, in contrast to the embodiments previously described, the flap 438 is attached to the top edge 468 of the cut out 424. As such, the first lower edge 410 of the blanket 400 is discontinuous, and is formed in two parts: a front portion 470 and a rear portion 472. A cut-out 424, or raised portion, is nevertheless still defined in the discontinuous first lower edge 410 of the blanket 400 through which the flap 438 may pass to wrap under the belly of the horse 416, as illustrated in FIG. 4c. In other words, when the blanket 400 is constructed, the first lower edge 410 at least partially defines the cut out 424 through which the flap 438 passes to wrap under the belly of the horse 416. Top layer 480 of blanket 400 also differs from top layer 380 of blanket 300 in that it is not waterproof and is made from a mesh fabric.

Although the appended claims are directed to particular combinations of features, it should be understood that the scope of the disclosure also includes other combinations of features disclosed herein either explicitly or implicitly, or any generalisation thereof, whether or not it relates to the same invention as presently claimed in any claim and whether or not it mitigates any or all of the same technical problems as does the present invention. The claims may therefore be reformulated to relate to any disclosed combination of features described herein, and the invention need not be defined as per the appended claims.

1. A horse blanket comprising:
a lower edge at least partially defining a cut out; and
a flap having a loose edge that overlaps the lower edge, the flap being configured to pass through the cut out to wrap against the belly of a horse when the blanket is secured to the horse.

2. A horse blanket according to claim 1, wherein the loose edge of the flap overlaps the lower edge within the cut out.

3. A horse blanket according to claim 1, wherein the lower edge is discontinuous with the loose edge of the flap.

4. A horse blanket according to claim 1, wherein the flap partially overlays the cut out in use.

5. A horse blanket according to claim 1, wherein a front portion of the lower edge extends below an elbow of the horse and a rear portion of the lower edge extends below a stifle of the horse.

6. A horse blanket according to claim 1, wherein the cut out partially defines a front lower portion of the blanket and a rear lower portion of the blanket, the cut out being located between the front lower portion and the rear lower portion.

7. A horse blanket according to claim 6, wherein the front lower portion of the blanket is disposed over an upper part of a foreleg of the horse when the blanket is worn by the horse, and the rear lower portion of the blanket is disposed over an upper part of a hind leg of the horse when the blanket is worn by the horse.

8. A horse blanket according to claim 7, wherein the front lower portion of the blanket is disposed over an elbow of the horse when the blanket is worn by the horse, and the rear lower portion of the blanket is disposed over a stifle of the horse when the blanket is worn by the horse.

9. A horse blanket according to claim 6, wherein the flap partially overlaps the front and rear lower portions of the blanket.

10. A horse blanket according to claim 1, wherein the cut out is situated adjacent to a flank or the belly of the horse when the blanket is worn by the horse.

11. A horse blanket according to claim 1, wherein the lower edge is discontinuous.

12. A horse blanket according to claim 1, wherein the flap extends below the lowest point of the lower edge when allowed to hang freely.

13. A horse blanket according to claim 1, wherein the lower edge and the loose edge of the flap cooperate to provide a discontinuous hemline.

14. A horse blanket according to claim 13, wherein the loose edge of the flap cooperates with the lower edge to define a front notch in the hemline.

15. A horse blanket according to claim 14, wherein the front notch is located adjacent to or rearwards of an elbow of the horse when the horse is stood in the square halt position while wearing the blanket.

16. A horse blanket according to claim 13, wherein the loose edge of the flap cooperates with the lower edge to define a rear notch in the hemline.

17. A horse blanket according to claim 16, wherein the rear notch is located adjacent to or forwards of a stifle of the horse when the horse is stood in the square halt position while wearing the blanket.

18. A horse blanket according to claim 1, wherein the blanket comprises:
a main part that extends across the back of the horse and down each side of the horse, the main part comprising the flap; and
a skirt part attached to the main part, wherein the lower edge of the skirt part is the lower edge of the blanket.

19. A horse blanket according to claim 18, wherein the skirt part is attached to the underside of the main part.

20. A horse blanket according to claim 18, wherein the skirt part is waterproof or water resistant.

21. A horse blanket according to any one of claim 18, wherein the skirt part does not comprise a filling material.

22. A horse blanket according to claim 1, wherein the blanket comprises a main part that extends across the back of the horse and down each side of the horse, wherein a lower edge of the main part is the lower edge of the blanket, and wherein the flap is attached to the main part.

23. A horse blanket according to claim 1, further comprising one or more straps configured to extend under the belly of the horse to secure the blanket on the horse, wherein the straps overlay the flap when the blanket is secured to the horse to hold the flap against the belly of the horse.

24. A horse blanket according to claim 1, wherein the flap is configured to wrap under the belly of the horse from one side of the horse to meet a second flap of the blanket wrapped under the belly of the horse from the opposing side of the horse.

25. A horse blanket according to claim 24, wherein the flaps each comprise a hook-and-loop fastening strip for securing the flaps together under the belly of the horse.
